(19) United States
(12) Patent Application Publication
(10) Pub. No.: US 2025/0274480 A1
(43) Pub. Date: Aug. 28, 2025

(54) Intelligent Attack Vector Analysis and Mitigation System

(71) Applicant: Bank of America Corporation, Charlotte, NC (US)

(72) Inventors: Suryanarayana Adivi, Hyderabad, Telangana (IN); Pushkar Taneja, Hyderabad, Telangana (IN); Durga Prasad Kutthumolu, Hyderabad, Telangana (IN); Sahas Shivling Sakhare, Hyderabad, Telangana (IN); Shailendra Singh, Thane West, Maharashtra (IN)

(73) Assignee: Bank of America Corporation, Charlotte, NC (US)

(21) Appl. No.: 18/586,805

(22) Filed: Feb. 26, 2024

(51) Int. Cl. H04L 9/40

(52) U.S. Cl. CPC H04L 63/1441; H04L 63/08; H04L 63/1425

(57) ABSTRACT

An intelligent attack vector analysis and mitigation system incorporates an intelligent process to analyze potential attack vectors from a suspicious attacker. The intelligent attack vector analysis and mitigation system leverages a generative artificial intelligence (AI)-enabled simulation environment to isolate and/or simulate attackers using federated identity and a hypermedia application programming interface (API). The system analyzes actual and/or potential attack vectors by leveraging the generative AI simulation and provides behavioral analysis with a specific focus on federated identity and/or hypermedia API components. As such, the system provides insights into novel attack vectors, vulnerabilities, and effective mitigation strategies that may then be automatically incorporated and/or implemented on the enterprise network by the intelligent attack vector analysis and mitigation system. The process utilizes continuous improvement, adaptation to evolving threats, and a holistic understanding of the system's security posture to improve and enable the enterprise organization's network security system.

### BACKGROUND

Large organizations, such as financial institutions and other large enterprise organizations, may provide many different products and/or services. To support these complex and large-scale operations, a large organization may own, operate, and/or maintain many different computer systems that service different internal users and/or external users in connection with different products and services. In addition, some computer systems internal to the organization may be configured to exchange information with computer systems external to the organization so as to provide and/or support different products and services offered by the organization.

As a result of the complexity associated with the operations of a large organization and its computer systems, it may be difficult for such an organization, such as a financial institution, to manage its computer systems efficiently, effectively, securely, and uniformly, and particularly manage how internal computer systems exchange information with external computer systems in providing and/or supporting different products and services offered by the organization. Often, such sharing of information may be performed via use of application programming interfaces (APIs). As such, malicious actors may attempt to leverage an API interface to improperly access an enterprise network.

When an enterprise organization detects that an API is being targeted by an attacker or suspicious caller, the enterprise organization attempts to defend by applying blocking strategies. Unfortunately, such strategies are not able to identify the attackers and/or gather additional intelligence related to the attacks, such as the tools and techniques employed by the attackers and the attacker's intent. In some cases, additional to use of a blocking strategy, an enterprise organization may dynamically incorporate a deceit and engagement strategy in an attempt to counteract a malicious user by intelligently leading them into a counter-intelligence network zone that challenges the attackers with additional authentication factors and serving them business-like APIs that may assist in an attempt to gain access and/or take control of a hacker's infrastructure.

Illustrative attack methodologies include (1) Unauthorized API Access where attackers attempt to access restricted APIs or sensitive endpoints without proper authentication or authorization, (2) API Brute-Force Attack: where an attacker attempts to gain unauthorized access to an API by repeatedly sending login requests with different username/password combinations, (3) API Injection Attacks, which is similar to structured query language (SQL) injection attacks where attackers manipulate API input parameters to execute unintended actions or access unauthorized data, (4) API Parameter Tampering, where attackers modify API request parameters to gain access to sensitive information or perform unintended actions, (5) API Denial of Service (DOS) Attack, where attackers flood the API with a large number of requests to overwhelm the server, causing it to become slow or unresponsive, API Phishing Attacks, where attackers create fake API endpoints or mimic legitimate APIs to deceive users into providing sensitive information, and/or the like.

Illustrative examples of actual attacks include a cryptocurrency exchange API Compromise and a securities trading platform outage. In 2017, a cryptocurrency exchange experienced an API-related security incident. Attackers used a phishing campaign to obtain API keys from the cryptocurrency exchange's users and then used these keys to execute unauthorized trades on their accounts. The incident highlighted the importance of protecting API keys and educating users about API security best practices. In March 2020, a popular retail securities trading platform experienced a prolonged outage during a period of high market volatility. The outage was attributed to a surge in user activity and API-related issues. The incident led to user frustration and raised concerns about the resilience and scalability of trading platforms during periods of market stress. Such API-related surge activities may be leveraged by malicious actors to force an enterprise organization into an outage condition, thus representing a security risk to both reputation and/or to mask other malicious activities.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary presents some concepts of the disclosure in a simplified form as a prelude to the description below.

Aspects of the disclosure relate to computer systems that provide effective, efficient, scalable, and convenient ways of securely and uniformly managing how internal computer systems exchange information with external computer systems to provide and/or support different products and services offered by an organization (e.g., a financial institution, and the like).

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes use of an intelligent simulation environment to isolate attackers and/or to gain insight into an attacker's intent and a system to mitigate an effect of an API-based attack on an enterprise network.

Aspects of the disclosure relate to computer hardware and software. In particular, one or more aspects of the disclosure generally relate to computer hardware and software for analyzing potential attack vectors from a suspicious source leveraging a generative artificial intelligence-enabled simulation environment for attackers using federated identity and hypermedia application programming interfaces, and mitigating identified attacks based on that analysis.

An intelligent attack vector analysis and mitigation system may incorporate an intelligent process to analyze potential attack vectors from a suspicious attacker. The intelligent attack vector analysis and mitigation system may leverage a generative AI-enabled simulation environment to isolate and/or simulate attackers using federated identity and a hypermedia API. The intelligent attack vector analysis and mitigation system may thus provide a comprehensive and innovative approach to analyze actual and/or potential attack vectors. The intelligent attack vector analysis and mitigation system, by leveraging the generative AI simulation, may provide behavioral analysis, with a specific focus on federated identity and/or hypermedia API components. As such organizations can gain insights into novel attack vectors, vulnerabilities, and effective mitigation strategies that may then be automatically incorporated and/or implemented on the enterprise network by the intelligent attack vector analysis and mitigation system. The process utilizes continuous improvement, adaptation to evolving threats, and a holistic understanding of the system's security posture to improve and enable the enterprise organization's network security system.

As discussed above, the intelligent attack vector analysis and mitigation system may enable and/or operate a generative AI simulation environment that provides a realistic simulation environment of the enterprise network operation using generative AI techniques to replicate attacker behavior and/or generate realistic attack patterns based on known tactics, techniques, and procedures (TTPs). The intelligent attack vector analysis and mitigation system may focus on federated identity and/or hypermedia APIs that may be specifically targeted in a malicious attack. In doing so, the intelligent attack vector analysis and mitigation system may analyze potential attack vectors unique to these environments by analyzing authentication, authorization, data flow, and/or interaction patterns. The intelligent attack vector analysis and mitigation system may incorporate intelligent algorithms and/or behavior analysis detection, such as via a behavior analysis and anomaly detection engine, to detect patterns, anomalies, and deviations from normal behavior within the simulation environment. In doing so, the intelligent attack vector analysis and mitigation system may be capable of identifying potential attack vectors that may go unnoticed by traditional rule-based methods.

The intelligent attack vector analysis and mitigation system may incorporate adversarial machine learning techniques to simulate adaptive attackers that modify their behavior to bypass security measures. Using this information, the intelligent attack vector analysis and mitigation system may assess the enterprise network security system's resilience against evolving attack techniques. Additionally, the intelligent attack vector analysis and mitigation system may perform cross-domain analysis by analyzing an impact of real and/or simulated attack vectors across different domains and systems. Here, the intelligent attack vector analysis and mitigation system may evaluate potential weaknesses and/or vulnerabilities that may span multiple system components, sub-networks, and/or organizations.

The intelligent attack vector analysis and mitigation system utilizes a generative AI simulation environment to develop a realistic simulation environment that mimics attacker behavior based on historical data and known tactics, techniques, and procedures (TTPs). The intelligent attack vector analysis and mitigation system may focus on federated identity and/or hypermedia APIs to allow for specific analysis of attack vectors that attempt to utilize vulnerabilities within these federated identity and hypermedia API components. Advanced behavioral analysis techniques and intelligent algorithms may be employed by the intelligent attack vector analysis and mitigation system to detect anomalies (e.g., anomalous behaviors) and/or to identify subtle patterns of attack behavior (e.g., characteristic behavior patterns). Adversarial machine learning (ML) (e.g., via a generative adversarial network (GAN)) may be used by the intelligent attack vector analysis and mitigation system to incorporate adversarial machine learning techniques to simulate adaptive attackers and to dynamically assess the system's resilience against evolving threats. By considering specific protocols, standards, and/or security mechanisms used within the federated identity and hypermedia API components, the intelligent attack vector analysis and mitigation system may analyze potential attack behavior with a deeper understanding of potential vulnerabilities. Because multiple domains may be targeted during an attack, the intelligent attack vector analysis and mitigation system may utilize cross-domain analysis to assess an impact of attack vectors across multiple systems, services, or organizations to uncover weaknesses that span different domains. Additionally, the intelligent attack vector analysis and mitigation system may allow for increased collaboration and/or knowledge sharing among security professionals, researchers, and/or stakeholders to enhance threat intelligence and collectively improve analysis outcomes, such as via sharing of anonymized attack vectors and/or data sets.

By implementing these solutions, organizations can gain insights into novel attack vectors, uncover hidden vulnerabilities, and develop effective mitigation strategies. This comprehensive approach ensures a proactive stance against potential threats, enabling organizations to strengthen their security posture in federated identity and hypermedia API environments.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIG. 1A shows an illustrative computing environment for analysis and mitigation of potential attack vectors targeting an API interface into an enterprise network, in accordance with one or more aspects described herein;

FIG. 1B shows an illustrative computing platform enabled for analysis and mitigation of potential attack vectors targeting an API interface into an enterprise network, in accordance with one or more aspects described herein;

FIG. 2 shows illustrative a process for analysis and mitigation of potential attack vectors targeting an API interface into an enterprise network in accordance with one or more aspects described herein;

FIG. 3 show an illustrative architecture diagram for analysis and mitigation of potential attack vectors targeting an API interface into an enterprise network, in accordance with one or more example arrangements; and

FIG. 4 shows an illustrative architecture diagram of a generative AI-based analysis system in accordance with one or more aspects described herein.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

As used throughout this disclosure, computer-executable “software and data” can include one or more: algorithms, applications, application program interfaces (APIs), attachments, big data, daemons, emails, encryptions, databases, datasets, drivers, data structures, file systems or distributed file systems, firmware, graphical user interfaces, images, instructions, machine learning (e.g., supervised, semi-supervised, reinforcement, and unsupervised), middleware, modules, objects, operating systems, processes, protocols, programs, scripts, tools, and utilities. The computer-executable software and data is on tangible, computer-readable memory (local, in network-attached storage, or remote), can be stored in volatile or non-volatile memory, and can operate autonomously, on-demand, on a schedule, and/or spontaneously.

“Computer machines” can include one or more: general-purpose or special-purpose network-accessible administrative computers, clusters, computing devices, computing platforms, desktop computers, distributed systems, enterprise computers, laptop or notebook computers, primary node computers, nodes, personal computers, portable electronic devices, servers, node computers, smart devices, tablets, and/or workstations, which have one or more microprocessors or executors for executing or accessing the computer-executable software and data. References to computer machines and names of devices within this definition are used interchangeably in this specification and are not considered limiting or exclusive to only a specific type of device. Instead, references in this disclosure to computer machines and the like are to be interpreted broadly as understood by skilled artisans. Further, as used in this specification, computer machines also include all hardware and components typically contained therein such as, for example, processors, executors, cores, volatile and non-volatile memories, communication interfaces, etc.

Computer “networks” can include one or more local area networks (LANs), wide area networks (WANs), the Internet, wireless networks, digital subscriber line (DSL) networks, frame relay networks, asynchronous transfer mode (ATM) networks, virtual private networks (VPN), or any combination of the same. Networks also include associated “network equipment” such as access points, ethernet adaptors (physical and wireless), firewalls, hubs, modems, routers, and/or switches located inside the network and/or on its periphery, and software executing on the foregoing.

The above-described examples and arrangements are merely some examples of arrangements in which the systems described herein may be used. Various other arrangements employing aspects described herein may be used without departing from the innovative concepts described.

An intelligent attack vector analysis and mitigation system may incorporate a simulation engine, an analysis engine, and a threat mitigation engine. The simulation engine may manage a generative AI simulation environment that may be configured to leverage AI techniques, machine learning models, and historical attack data. The simulation engine can dynamically generate realistic attack patterns and behaviors of malicious actors to allow the intelligent attack vector analysis and mitigation system to explore and evaluate potential attack vectors in a controlled and adaptable manner. The analysis engine may integrate federated identity functionality and/or hypermedia APIs to allow for a deeper understanding of the vulnerabilities and risks associated with these technologies. By simulating realistic interactions and data flows, the analysis engine can identify unique attack vectors that specifically target federated identity and hypermedia API components. Additionally, the analysis engine may perform dynamic exploration of attack vectors by leveraging the dynamic nature of the generative AI simulation environment to explore various attack vectors in real-time. Additionally, the analysis engine may simulate attacker behavior, monitor an attacker's and/or a simulated attacker's interactions with the federated identity and hypermedia API components to dynamically identify novel attack vectors as they emerge. This dynamic exploration allows the analysis engine to uncover non-obvious attack vectors that may be missed in static analysis approaches. The analysis engine may perform behavior-based anomaly detection through use of intelligent algorithms and behavioral analysis techniques for anomaly detection to identify potential attack vectors. By analyzing patterns and deviations from normal behavior, the analysis engine can detect subtle and evolving attack techniques that might be missed by traditional rule-based methods. This information may be leveraged by the threat mitigation engine by uncovering novel attack vectors that utilize specific weaknesses in the federated identity and hypermedia API components, which then can be countered by fixes identified and/or automatically initiated by the threat mitigation engine. The intelligent attack vector analysis and mitigation system provides organizations with an innovative and comprehensive approach to analyze and identify mitigation techniques to counter potential attack vectors. The intelligent attack vector analysis and mitigation system enables the discovery of novel vulnerabilities, the identification of emerging attack techniques, and the development of effective mitigation strategies in federated identity and hypermedia API environments.

Features of the intelligent attack vector analysis and mitigation system may include realistic simulation capability, use of adaptive attacker models, modeling of dynamic adversary behavior, and an intelligent response simulation to quantify results of identified potential responses to the modeled dynamic adversary behavior. Generating realistic data for the simulation environment is a primary feature of the intelligent attack vector analysis and mitigation system's abilities. The generative AI model may be trained on diverse and representative datasets, including real-world attack patterns, user behaviors, and/or API interactions to ensure that the simulation accurately reflects the complexity and nuances of actual attacker activities. Create adaptive attacker models within the simulation environment may be capable of evolving and learning from identified real and/or simulated successful attack patterns, reacting to malicious user's adaptations of their techniques, and exploring new attack vectors. Such activities allow the intelligent attack vector analysis and mitigation system to identify emerging attack vectors that may not have been previously considered. The simulation environment allows the intelligent attack vector analysis and mitigation system simulate dynamic and adaptive attacker behavior. Because real attackers often modify their tactics based on the target environment and the defensive measures in place, such an ability allows the intelligent attack vector analysis and mitigation system to further evaluate the system's security measures within a dynamically changing environment.

Additionally, the intelligent attack vector analysis and mitigation system may include an intelligent response simulation environment, an interface to allow for supplemental activities provided via a human-in-the loop approach. By extending the simulation environment to include intelligent response simulation, the intelligent attack vector analysis and mitigation system can provide a more comprehensive evaluation of an attacker's actions and a way to evaluate the effectiveness of the enterprise network system's defenses. While AI simulation plays a crucial role, involving human experts may further enhance the intelligent attack vector analysis and mitigation system by allowing for additional interpretation of results, validation of findings, and/or utilization of additional domain expertise. In doing so, the intelligent attack vector analysis and mitigation system utilizes interaction between human analysts and the generative AI simulation environment to augment automated results with additional human insights, critical thinking, and experience to complement the AI-generated insights.

The intelligent attack vector analysis and mitigation system provides contextual understanding of the federated identity and hypermedia API components during analysis. This includes considering the interactions between different components, understanding the protocols and standards used, and assessing the security mechanisms in place. By understanding the context, the intelligent attack vector analysis and mitigation system can identify nuanced attack vectors that attempt to utilize specific weaknesses and/or vulnerabilities unique to the federated identity and hypermedia API environment. Further, the intelligent attack vector analysis and mitigation system utilizes cross domain analysis by considering a potential impact of attack vectors across different domains. Attackers targeting the federated identity and hypermedia API components may attempt to utilize vulnerabilities that span multiple systems, services, or organizations. By analyzing one or more attack vectors from a cross-domain perspective, the intelligent attack vector analysis and mitigation system may identify potential weaknesses in the overall system and address them comprehensively. Using such features, the intelligent attack vector analysis and mitigation system provides a complex and sophisticated dynamic self-learning environment. The integration of advanced AI techniques, contextual analysis, collaboration, and human expertise helps to uncover subtle attack vectors that may not be immediately apparent to enhance the overall effectiveness of the analysis process performed by the intelligent attack vector analysis and mitigation system.

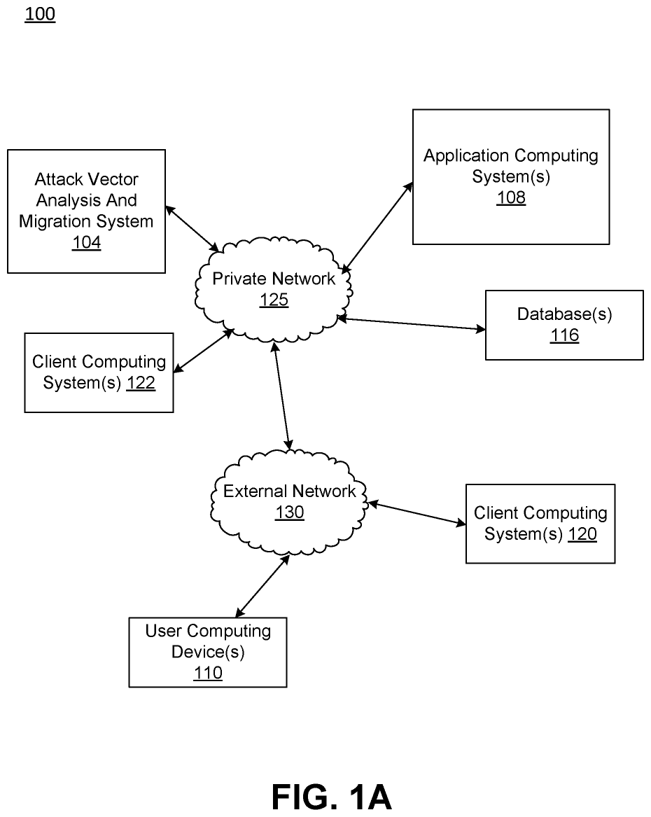

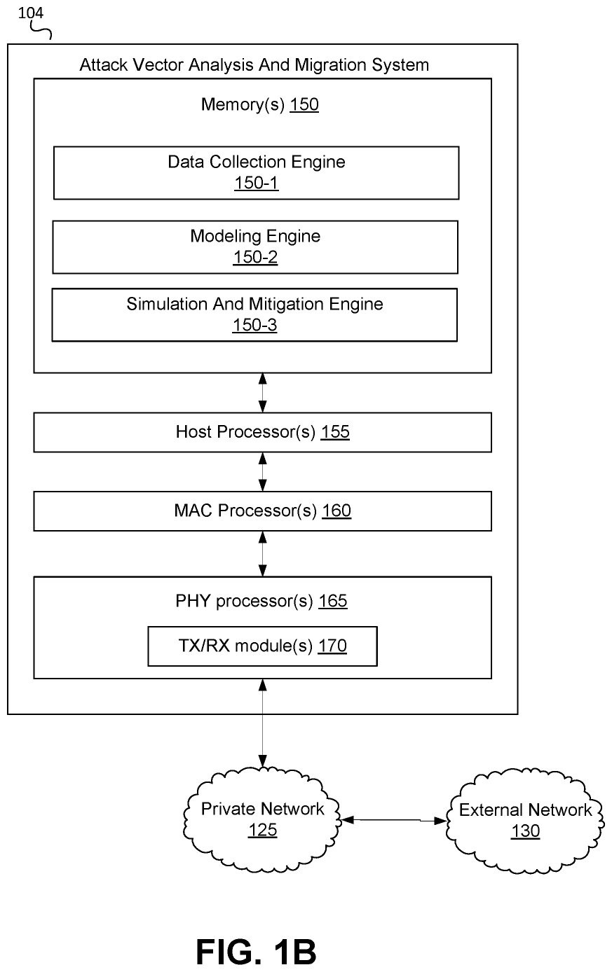

FIG. 1A shows an illustrative computing environment 100 for analysis and mitigation of potential attack vectors targeting an API interface into an enterprise network, in accordance with one or more arrangements. The computing environment 100 may comprise one or more devices (e.g., computer systems, communication devices, and the like). The computing environment 100 may comprise, for example, an attack vector analysis and mitigation system 104, one or more application computing systems 108, one or more client computing systems 122, and/or one or more database(s) 116. The one or more of the devices and/or systems, may be linked over a private network 125 associated with an enterprise organization (e.g., a financial institution, a business organization, an educational institution, a governmental organization and the like). The computing environment 100 may additionally comprise a client computing system 120 and one or more user devices 110 connected, via a public network 130, to the devices in the private network 125. The devices in the computing environment 100 may transmit/exchange/share information via hardware and/or software interfaces using one or more communication protocols. The communication protocols may be any wired communication protocol(s), wireless communication protocol(s), one or more protocols corresponding to one or more layers in the Open Systems Interconnection (OSI) model (e.g., local area network (LAN) protocol, an Institution of Electrical and Electronics Engineers (IEEE) 802.11 WIFI protocol, a 3rd Generation Partnership Project (3GPP) cellular protocol, a hypertext transfer protocol (HTTP), etc.). While FIG. 1A shows the attack vector analysis and mitigation system 104 as being a stand-alone system, the attack vector analysis and mitigation system 104 may be incorporated within one or more different computing systems, such as the application computing systems 108.

The attack vector analysis and mitigation system 104 may comprise one or more computing devices and/or other computer components (e.g., processors, memories, communication interfaces) configured to perform one or more functions as described herein. Further details associated with the architecture of the attack vector analysis and mitigation system 104 are described with reference to FIG. 1B.

The application computing systems 108 and/or the client computing systems 122 may comprise one or more computing devices and/or other computer components (e.g., processors, memories, communication interfaces). In addition, the application computing systems 108 and/or the client computing systems 122 may be configured to host, execute, and/or otherwise provide one or more enterprise applications. In some cases, the application computing systems 108 may host one or more services configured facilitate operations requested through one or more API calls, such as data retrieval and/or initiating processing of specified functionality. In some cases, the client computing systems 122 may be configured to communicate with one or more of the application computing systems 108 such as via direct communications and/or API function calls and the services. In an arrangement where the private network 125 is associated with a financial institution (e.g., a bank), the application computing systems 108 may be configured, for example, to host, execute, and/or otherwise provide one or more transaction processing programs, such as an online banking application, fund transfer applications, and/or other programs associated with the financial institution. The client computing systems 122 and/or the application computing systems 108 may comprise various servers and/or databases that store and/or otherwise maintain account information, such as financial account information including account balances, transaction history, account owner information, and/or other information. In addition, the client computing systems 122 and/or the application computing systems 108 may process and/or otherwise execute transactions on specific accounts based on commands and/or other information received from other computer systems comprising the computing environment 100. In some cases, one or more of the client computing systems 122 and/or the application computing systems 108 may be configured, for example, to host, execute, and/or otherwise provide one or more transaction processing programs, such as electronic fund transfer applications, online loan processing applications, and/or other programs associated with the financial institution.

The application computing systems 108 may be one or more host devices (e.g., a workstation, a server, and the like) or mobile computing devices (e.g., smartphone, tablet). In addition, an application computing systems 108 may be linked to and/or operated by a specific enterprise user (who may, for example, be an employee or other affiliate of the enterprise organization) who may have administrative privileges to perform various operations within the private network 125. In some cases, the application computing systems 108 may be capable of performing one or more layers of user identification based on one or more different user verification technologies including, but not limited to, password protection, pass phrase identification, biometric identification, voice recognition, facial recognition and/or the like. In some cases, a first level of user identification may be used, for example, for logging into an application or a web server and a second level of user identification may be used to enable certain activities and/or activate certain access rights.

The client computing systems 120 may comprise one or more computing devices and/or other computer components (e.g., processors, memories, communication interfaces). The client computing systems 120 may be configured, for example, to host, execute, and/or otherwise provide one or more transaction processing programs, such as goods ordering applications, electronic fund transfer applications, online loan processing applications, and/or other programs associated with providing a product or service to a user. With reference to the example where the client computing systems 120 is for processing an electronic exchange of goods and/or services. The client computing systems 120 may be associated with a specific goods purchasing activity, such as purchasing a vehicle, transferring title of real estate may perform communicate with one or more other platforms within the client computing systems 120. In some cases, the client computing systems 120 may integrate API calls to request data, initiate functionality, or otherwise communicate with the one or more application computing systems 108, such as via the services. For example, the services may be configured to facilitate data communications (e.g., data gathering functions, data writing functions, and the like) between the client computing systems 120 and the one or more application computing systems 108.

The user device(s) 110 may be computing devices (e.g., desktop computers, laptop computers) or mobile computing device (e.g., smartphones, tablets) connected to the network 125. The user device(s) 110 may be configured to enable the user to access the various functionalities provided by the devices, applications, and/or systems in the network 125.

The database(s) 116 may comprise one or more computer-readable memories storing information that may be used by attack vector analysis and mitigation system 104. For example, the database(s) 116 may store information corresponding suspicious attackers, such as behavior, tactics, techniques, procedures, attack patterns and/or indicators of compromise, threat models, simulated attack scenarios, and the like. In an arrangement, the database(s) 116 may be used for other purposes as described herein. In some cases, the client computing system 120 may write data or read data to the database(s) 116 via the services.

In one or more arrangements, the attack vector analysis and mitigation system 104, the application computing systems 108, the client computing systems 122, the client computing systems 120, the user devices 110, and/or the other devices/systems in the computing environment 100 may be any type of computing device capable of receiving input via a user interface, and communicating the received input to one or more other computing devices in the computing environment 100. For example, the attack vector analysis and mitigation system 104, the application computing systems 108, the client computing systems 122, the client computing systems 120, the user devices 110, and/or the other devices/systems in the computing environment 100 may, in some instances, be and/or include server computers, desktop computers, laptop computers, tablet computers, smart phones, wearable devices, or the like that may comprised of one or more processors, memories, communication interfaces, storage devices, and/or other components. Any and/or all of the attack vector analysis and mitigation system 104, the application computing systems 108, the client computing systems 122, the client computing systems 120, the user devices 110, and/or the other devices/systems in the computing environment 100 may, in some instances, be and/or comprise special-purpose computing devices configured to perform specific functions.

FIG. 1B shows an illustrative attack vector analysis and mitigation system 104 in accordance with one or more examples described herein. The attack vector analysis and mitigation system 104 may be a stand-alone device and/or may at least be partial integrated with the development computing system 104 may comprise one or more of host processor(s) 155, medium access control (MAC) processor(s) 160, physical layer (PHY) processor(s) 165, transmit/receive (TX/RX) module(s) 170, memory 150, and/or the like. One or more data buses may interconnect host processor(s) 155, MAC processor(s) 160, PHY processor(s) 165, and/or Tx/Rx module(s) 170, and/or memory 150. The attack vector analysis and mitigation system 104 may be implemented using one or more integrated circuits (ICs), software, or a combination thereof, configured to operate as discussed below. The host processor(s) 155, the MAC processor(s) 160, and the PHY processor(s) 165 may be implemented, at least partially, on a single IC or multiple ICs. The memory 150 may be any memory such as a random-access memory (RAM), a read-only memory (ROM), a flash memory, or any other electronically readable memory, or the like.

Messages transmitted from and received at devices in the computing environment 100 may be encoded in one or more MAC data units and/or PHY data units. The MAC processor(s) 160 and/or the PHY processor(s) 165 of the attack vector analysis and mitigation system 104 may be configured to generate data units, and process received data units, that conform to any suitable wired and/or wireless communication protocol. For example, the MAC processor(s) 160 may be configured to implement MAC layer functions, and the PHY processor(s) 165 may be configured to implement PHY layer functions corresponding to the communication protocol. The MAC processor(s) 160 may, for example, generate MAC data units (e.g., MAC protocol data units (MPDUs)), and forward the MAC data units to the PHY processor(s) 165. The PHY processor(s) 165 may, for example, generate PHY data units (e.g., PHY protocol data units (PPDUs)) based on the MAC data units. The generated PHY data units may be transmitted via the TX/RX module(s) 170 over the private network 125. Similarly, the PHY processor(s) 165 may receive PHY data units from the TX/RX module(s) 165, extract MAC data units encapsulated within the PHY data units, and forward the extracted MAC data units to the MAC processor(s). The MAC processor(s) 160 may then process the MAC data units as forwarded by the PHY processor(s) 165.

One or more processors (e.g., the host processor(s) 155, the MAC processor(s) 160, the PHY processor(s) 165, and/or the like) of the attack vector analysis and mitigation system 104 may be configured to execute machine readable instructions stored in memory 150. The memory 150 may comprise (i) one or more program modules/engines having instructions that when executed by the one or more processors cause the attack vector analysis and mitigation system 104 to perform one or more functions described herein and/or (ii) one or more databases that may store and/or otherwise maintain information which may be used by the one or more program modules/engines and/or the one or more processors. The one or more program modules/engines and/or databases may be stored by and/or maintained in different memory units of the attack vector analysis and mitigation system 104 and/or by different computing devices that may form and/or otherwise make up the attack vector analysis and mitigation system 104. For example, the memory 150 may have, store, and/or comprise a data collection engine 150-1, a modeling engine 150-2, a simulation and mitigation engine 150-3, and/or the like. The data collection engine 150-1 may have instructions that direct and/or cause the attack vector analysis and mitigation system 104 to perform one or more operations associated with collecting relevant data about one or more suspicious users (e.g., suspected attackers), including behavior, tactics, techniques, and procedures (TTPs), attack patterns and any available indicators of compromise (IOCs), and the like. The modeling engine 150-2 may have instructions that may cause the attack vector analysis and mitigation system 104 to perform generative AI simulation operations, such as by generating realistic attack patterns based on known attacker TTPs, incorporating federated identity and hypermedia API elements of the enterprise organization network-based systems. The simulation and mitigation engine 150-3 may have instructions that may cause the attack vector analysis and mitigation system 104 to perform analysis of generative AI environment simulations, such as by focusing on specific attack vectors related to federated identity and/or hypermedia API functionality. Additionally, the simulation and mitigation engine 150-3 may further analyze identified attack vectors, determine a level of risk associated with each attack vector and determine and/or implement one or more risk mitigation strategies.

While FIG. 1A illustrates the attack vector analysis and mitigation system 104 and the application computing systems 108, as being separate elements connected in the private network 125, in one or more other arrangements, functions of one or more of the above may be integrated in a single device/network of devices. For example, elements in the attack vector analysis and mitigation system 104 (e.g., host processor(s) 155, memory(s) 150, MAC processor(s) 160, PHY processor(s) 165, TX/RX module(s) 170, and/or one or more program/modules stored in memory(s) 150) may share hardware and software elements with and corresponding to, for example, the application computing systems 108.

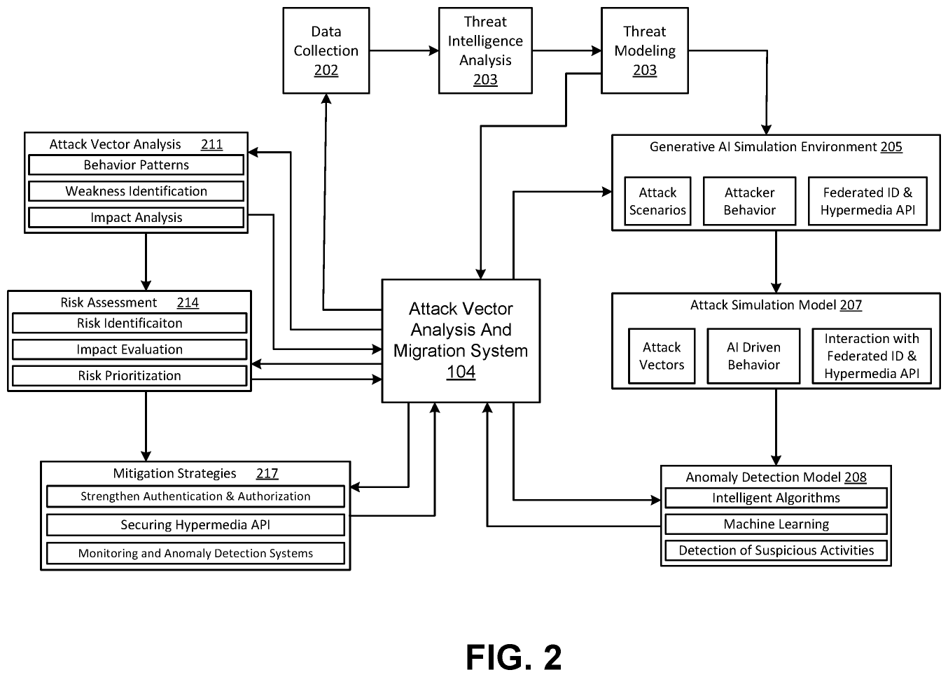

FIG. 2 shows illustrative a process for analysis and mitigation of potential attack vectors targeting an API interface into an enterprise network in accordance with one or more aspects described herein. The attack vector analysis and mitigation system 104 may perform data collection activities, such as by monitoring network communication activities, analyzing data logs and/or the like. For example, relevant data corresponding to potential attack or other malicious activities may be captured and aggregated from multiple network sources, such as behavior, tactics, techniques, and procedures (TTPs), attack patterns, and any available indicators of compromise of the network computing devices at 202. At 203, the attack vector analysis and mitigation system 104 may perform threat intelligence activities to integrate threat intelligence feeds with real-time information sources into the system. At 203, the attack vector analysis and mitigation system 104 may use the aggregated data and/or real-time threat feeds to generate a threat model that may be used to identify potential vulnerabilities, entry points, and/or critical assets that an attacker or other malicious actor may attempt to leverage for unauthorized access into the enterprise computing system.

At 205, the generative AI simulation environment may be provided prompts, such as from the attack vector analysis and mitigation system 104 and/or with threat model information to generate one or more attack scenarios, one or more models of potential attacker and/or malicious user behavior, and/or federated identifier and/or hypermedia API information. The generated information, models, and/or simulations may be utilized by the attack vector analysis and mitigation system 104 in an attack simulation model 207, that may simulate use of the generated attack vectors, while simulating malicious users or attackers performing actions on the network including interactions with a federated Id system and/or with hypermedia API functionality. For example, the attack simulation model 207 represents the environment where the generative AI simulation takes place. The attack vector analysis and mitigation system 104 may utilize realistic attack patterns based on known attacker TTPs, while incorporating federated identity and hypermedia API elements. The simulated attacks within the generative AI environment may be analyzed by the attack vector analysis and mitigation system 104. In some cases, the analysis may focus on certain network functions and/or functionality that may be leveraged by malicious users, such as by focusing on the specific attack vectors related to federated identity and hypermedia API.

The hypermedia API may serve hypermedia responses with attack patters and/or simulation scenarios. These simulations and/or attack patterns allow the attack vector analysis and mitigation system 104 to dynamically navigate through API functionalities to provide resources for attack analysis during the simulations. The federated identity system may handle user authentication and/or authorization activities for the enterprise computing network. The federated identity system may issue security tokens to enable API access and/or may provide single sign-on (SSO) functionality.

The anomaly detection model 208 may analyze data generated form the simulation environment to understand effectiveness of a potential attacker's techniques and/or the actions impact on the federated identity and/or hypermedia API components. For example, the anomaly detection model may utilize machine learning algorithms, intelligent algorithms to process the simulation data collected in response to the generative AI generated attack scenarios and/or attack behaviors processed in the attack simulation environment. This analysis may allow for detection of suspicious activities or other malicious behaviors throughout the network based on identified paths of compromise.

The attack vector analysis and mitigation system 104 may perform attack vector analysis 211 to, for example, identify behavior patterns, identify weaknesses of the enterprise network that may be subject to improper use by malicious actors, and/or to perform an impact analysis of the identified behavior patterns, identified weaknesses, and/or the like. In some cases, the data generated from the simulation environment may be analyzed to understand the effectiveness of the attacker's techniques and their impact on the federated identity and hypermedia API components. At 214, the attack vector analysis and mitigation system 104 may perform one or more risk assessment activities, such as to identify potential risks, perform an impact evaluation for each identified risk, and/or to prioritize identified risks based on the impact evaluation and/or an identified severity of each identified potential risk. For example, identified attack vectors may be assessed to determine potential risks, considering the impact on data confidentiality, integrity, availability, and overall system security. At 217, the attack vector analysis and mitigation system 104 may generate and/or implement one or more risk mitigation strategies, automatically and/or with some human interaction. For example, risk mitigation strategies may include strengthening authentication and/or authentication functionalities, securing hypermedia API functionalities, improving monitoring activities, and/or improving or implementing an anomaly detection system. Based on the risk assessment, mitigation strategies may be developed by the attack vector analysis and mitigation system 104 and/or automatically implemented to address the identified attack vectors, such as strengthening authentication and authorization mechanisms and securing the hypermedia API endpoints.

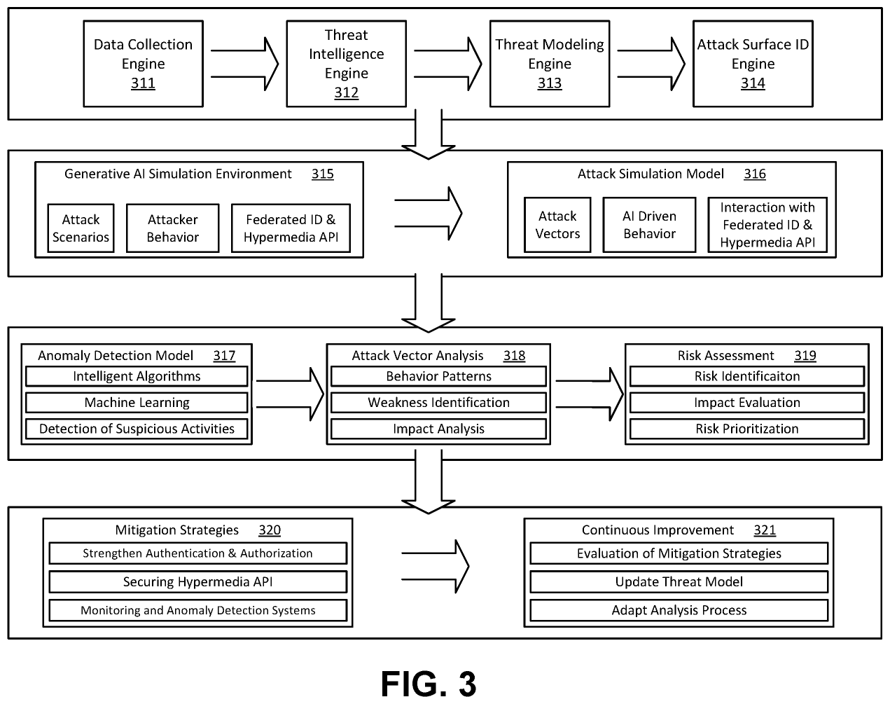

FIG. 3 show an illustrative architecture diagram for analysis and mitigation of potential attack vectors targeting an API interface into an enterprise network, in accordance with one or more arrangements. The attack vector analysis and mitigation system 104 may perform certain data collection, analysis, and/or modeling activities to form an information base that may be updated in real-time to allow for adaptive and intelligent modeling of potential threat actor actions when attempting to improperly access the enterprise network, such as by leveraging certain vulnerabilities and/or otherwise less secure network components. For example, a data collection engine 311, may aggregate or otherwise collect relevant data may be collected about a potential or real suspicious attacker, including behavior, tactics, techniques, and procedures (TTPs), attack patterns and any available indicators of compromise (IOCs). The threat intelligence engine 312 may integrate threat intelligence feeds of real-time information sources into the system. The threat modeling engine 313 may create a threat model to identify potential vulnerabilities, entry points, and critical assets that an attacker or other malicious user might improperly target. For example, the threat modeling engine 313 may generate a model specific to a particular target environment on the enterprise network (e.g., a common network entry point, a network interface of an application computing system, a user device-based entry point, and/or the like) and/or critical assets that an attacker or other malicious user may target. The attack surface identification engine 314 may generate a model specific to a target environment to allow the attack vector analysis and mitigation system 104 to understand an attack surface that may be exploited.

The generative AI simulation environment 315 may utilize attack scenarios and/or attacker behavior models and leverage federated ID and/or hypermedia API functionality within a generative AI environment to automatically generate realistic attacks to different entry points to the enterprise network. The simulated attacks within the generative AI environment are analyzed, focusing on the specific attack vectors related to federated identity and hypermedia API. The attack simulation model 316 may correspond to a modeling environment where the generative AI simulation takes place. It generates realistic attack patterns based on known attacker TTPs, incorporating federated identity and hypermedia API elements.

The anomaly detection model 317 may utilize intelligent algorithms and/or machine learning algorithms to automatically detect suspicious activities based on the simulations. For example, intelligent algorithms and anomaly detection techniques may be applied to identify deviations from normal behavior within the generative AI simulation. The attack vector analysis and mitigation system 104 may perform attack vector analysis 318 to identify behavior patterns, identify weaknesses that may be improperly utilized, and/or otherwise perform an impact analysis. Data generated from the simulation environment may be analyzed to understand the effectiveness of the attacker's techniques and their impact on the federated identity and hypermedia API components. The risk assessment activities 319 may be performed to identify risks, evaluate impact of each risk, and to prioritize each identified risk. For example, the identified attack vectors may be assessed to determine potential risks, considering the impact on data confidentiality, integrity, availability, and overall system security. In some cases, identifying risks include determining a risk score based on identified threats to private information, likelihood of improper use of network federated identity controls and/or hypermedia API functionality, and/or the like. In some cases, evaluating impact of each risk includes comparing a risk score to a predetermined threshold, and/or the like.

The attack vector analysis and mitigation system 104 may automatically generate one or more risk mitigation strategies such as to strengthen authentication and/or authentication processes, secure one or more hypermedia API functions, and/or may improve efficiency and/or effectiveness of network monitoring and/or anomaly detection systems. For example, based on the risk assessment, mitigation strategies may be automatically developed and implemented to address the identified attack vectors, such as strengthening authentication and authorization mechanisms and securing the hypermedia API endpoints. The attack vector analysis and mitigation system 104 may also include a continuous improvement model 321 that may continuously evaluate implemented risk mitigation strategies, ensure a threat model is continuously updates, such as in real time, and adapt one or more analysis processes performed by the attack vector analysis and mitigation system 104. For example, the effectiveness of the implemented mitigation strategies is evaluated, and the threat model and generative AI simulation environment are updated accordingly. This ensures that the analysis process adapts to emerging threats and evolving attack techniques.

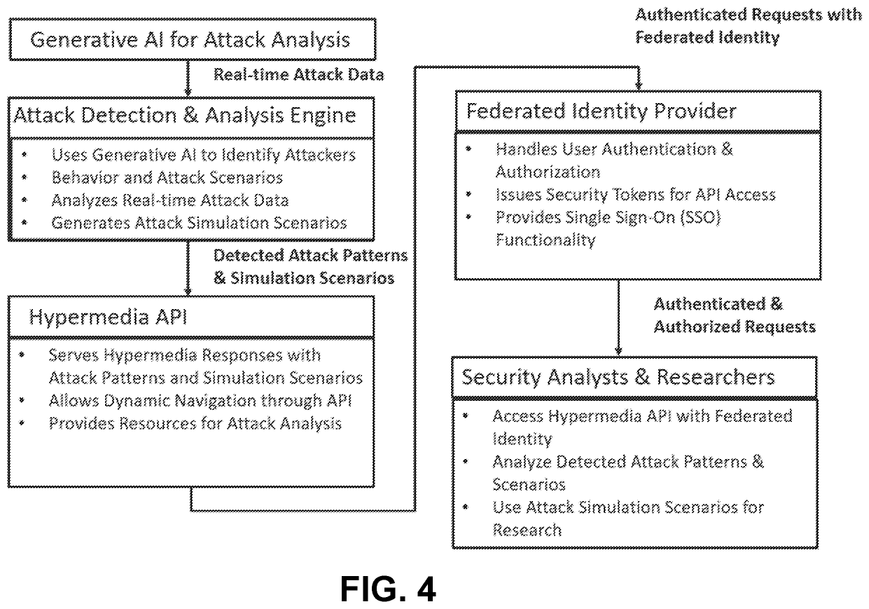

FIG. 4 shows an illustrative architecture diagram of a generative AI-based analysis system in accordance with one or more aspects described herein. The attack vector analysis and mitigation system 104 may perform multi-step generative AI-based attack analysis via an attack detection and analysis engine, utilize hypermedia API functionality and federated identity functionality and may provide security analysts and/or researchers with real-time simulated information. The attack detection and analysis engine may use generative AI to identify attackers and/or to identify potential attacker activities. Behavior and/or attack scenarios may be generated to allow for real-time analysis of attack data to generate attack simulation scenarios. Based on detected attack patterns and generated simulation scenarios a hypermedia API engine may serve hypermedia responses with attack patterns and simulation scenarios to allow for dynamic navigation through the API functionality to provide resources for attack analysis. Authenticated requests enabled with federated identity may be provided to a federated identity system to handle user authentication and authorization functionality that may issue security tokens for use when accessing API functionality and/or may provide single sign-on (SSO) functionality. Authenticated and/or authorized request may be analyzed by the attack vector analysis and mitigation system 104 to assess hypermedia API functionality when enabled with federated identity actions, analyze detected attack patterns and scenarios, and/or may use attack simulation scenarios for further research.

For example, attack vector analysis and mitigation system 104 may utilize generative AI functionality for attack analysis, where generative AI techniques may be used to analyze real-time attack data and identify patterns of malicious behavior and potential attack scenarios. Additionally, the attack vector and mitigation system 104 may include the attack detection and analysis engine that receives real-time attack data and uses the generative AI model to detect and analyze attackers' behavior and/or attack scenarios. The attack detection and analysis engine also generates simulated attack scenarios for further analysis. The hypermedia API serves hypermedia responses containing detected attack patterns, identified attacker behaviors, and generated attack simulation scenarios. Additionally, the hypermedia API allows dynamic navigation through the attack data for the attack vector analysis and mitigation system 104 which may also generate a user interface to allow system analysts and/or researchers to step through a simulated attack pattern and/or scenario, such as those automatically processed by the attack vector analysis and mitigation system 104. A federated identity system may handle user authentication and authorization for security analysts and researchers. It issues security tokens for API access and provides single sign-on (SSO) functionality for a seamless user experience. The attack vector analysis and mitigation system 104 may provide a user interface feature to allow users (e.g., security analysts and/or researchers or other responsible parties) to interact with the system through the Hypermedia API, authenticated with federated identity. They can analyze detected attack patterns, explore identified attacker behaviors, and utilize attack simulation scenarios for research purposes, such as by replaying the automated scenarios performed by the attack vector analysis and mitigation system 104.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally, or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

1. A system comprising:
a federated identity system managing user authentication processes for an enterprise network;
an attack vector analysis and mitigation platform, comprising:
a processor; and
memory storing computer-readable instructions that, when executed by the processor, cause the attack vector analysis and mitigation platform to:
aggregate, from a plurality of network sources, network access information corresponding to a plurality of users attempting to access the enterprise network;
generate, based on the aggregated network access information and a plurality of attack scenarios and characteristic attack behavior patterns;
process, using an attack simulation model, the plurality of attack scenarios using the characteristic behavior patterns to identify one or more attack vectors targeting the federated identity system;
identify, based on information corresponding to the one or more attack vectors targeting the federated identity system, attack effectiveness information and impact information on the federated identity system;
determine, based on the attack effectiveness information and the impact information, a data security risk; and
implement, automatically and at the federated identity system, a risk mitigation process based on an identified data security risk.

2. The system of claim 1, wherein the aggregated network access information comprises one or more of behavioral information, tactic, techniques, and procedure (TTP) information, attack pattern information, and network compromise information.

3. The system of claim 1, wherein the instructions cause the attack vector analysis and mitigation platform to integrate real-time threat intelligence feeds with the aggregated network access information.

4. The system of claim 1, wherein the plurality of attack scenarios and characteristic attack behavior patterns are generated via a generative artificial intelligence-based system.

5. The system of claim 1, wherein the instructions cause the attack vector analysis and mitigation platform to process, using the attack simulation model, the plurality of attack scenarios using the characteristic behavior patterns to identify one or more attack vectors targeting utilizing a hypermedia application programming interface (API).

6. The system of claim 5, wherein the instructions cause the attack vector analysis and mitigation platform to identify, based on information corresponding to the one or more attack vectors utilizing the hypermedia API, the attack effectiveness information, and the impact information on hypermedia API functionality.

7. The system of claim 6, wherein the instructions cause the attack vector analysis and mitigation platform to implement, automatically and to the hypermedia API, a risk mitigation process based on the identified data security risk.

8. A method comprising:
aggregating, from a plurality of network sources, network access information corresponding to a plurality of users attempting to access an enterprise network;
generating, based on the aggregated network access information and a plurality of attack scenarios and characteristic attack behavior patterns;
processing, using an attack simulation model, the plurality of attack scenarios using the characteristic behavior patterns to identify one or more attack vectors targeting a federated identity system;
identifying, based on information corresponding to the one or more attack vectors targeting the federated identity system, attack effectiveness information and impact information on the federated identity system;
determining, based on the attack effectiveness information and the impact information, a data security risk; and
implementing, automatically and at the federated identity system, a risk mitigation process based on an identified data security risk.

9. The method of claim 8, wherein the aggregated network access information comprises one or more of behavioral information, tactic, techniques, and procedure (TTP) information, attack pattern information, and network compromise information.

10. The method of claim 8, further comprising integrating real-time threat intelligence feeds with the aggregated network access information.

11. The method of claim 8, wherein the plurality of attack scenarios and characteristic attack behavior patterns are generated via a generative artificial intelligence-based system.

12. The method of claim 8, further comprising processing, using the attack simulation model, the plurality of attack scenarios using the characteristic behavior patterns to identify one or more attack vectors targeting utilizing a hypermedia application programming interface (API).

13. The method of claim 12, further comprising identifying, based on information corresponding to the one or more attack vectors utilizing the hypermedia API, the attack effectiveness information, and the impact information on hypermedia API functionality.

14. The method of claim 13, further comprising implementing, automatically and to the hypermedia API, a risk mitigation process based on the identified data security risk.

15. Non-transitory computer readable media storing instructions that, when executed by a processor, cause an attack vector analysis and mitigation platform to:
aggregate, from a plurality of network sources, network access information corresponding to a plurality of users attempting to access an enterprise network;
generate, based on the aggregated network access information and a plurality of attack scenarios and characteristic attack behavior patterns;
process, using an attack simulation model, the plurality of attack scenarios using the characteristic behavior patterns to identify one or more attack vectors targeting a federated identity system;
identify, based on information corresponding to the one or more attack vectors targeting the federated identity system, attack effectiveness information and impact information on the federated identity system;
determine, based on the attack effectiveness information and the impact information, a data security risk; and
implement, automatically and at the federated identity system, a risk mitigation process based on an identified data security risk.

16. The non-transitory computer readable media of claim 15, wherein the aggregated network access information comprises one or more of behavioral information, tactic, techniques, and procedure (TTP) information, attack pattern information, and network compromise information.

17. The non-transitory computer readable media of claim 15, wherein the instructions cause the attack vector analysis and mitigation platform to integrate real-time threat intelligence feeds with the aggregated network access information.

18. The non-transitory computer readable media of claim 15, wherein the plurality of attack scenarios and characteristic attack behavior patterns are generated via a generative artificial intelligence-based system.

19. The non-transitory computer readable media of claim 15, wherein the instructions cause the attack vector analysis and mitigation platform to process, using the attack simulation model, the plurality of attack scenarios using the characteristic behavior patterns to identify one or more attack vectors targeting utilizing a hypermedia application programming interface (API).

20. The non-transitory computer readable media of claim 19, wherein the instructions cause the attack vector analysis and mitigation platform to:
identify, based on information corresponding to the one or more attack vectors utilizing the hypermedia API, the attack effectiveness information, and the impact information on hypermedia API functionality; and
implement, automatically and to the hypermedia API, a risk mitigation process based on the identified data security risk.
